(19) United States
(12) Patent Application Publication
(10) Pub. No.: US 2015/0379547 A1
(43) Pub. Date: Dec. 31, 2015

(54) APPARATUS AND METHOD OF INCENTIVIZING A TARGETED PURCHASE USING MULTI-CHANNEL DATA

(71) Applicant: IGATE Global Solutions Ltd., Navi Mumbai (IN)

(72) Inventors: Anupam Raj Gautam, Navi Mumbai (IN); Ravikumar Krishnamoorthy, Navi Mumbai (IN); Venkatesh Babu, Navi Mumbai (IN); Ashok B. Yalamanchili, Navi Mumbai (IN); Suyog Joshi, Navi Mumbai (IN)

(21) Appl. No.: 14/538,074

(22) Filed: Nov. 11, 2014

(30) Foreign Application Priority Data
Jun. 30, 2014 (IN) 2111/MUM/2014

(51) Int. Cl. G06Q 30/02; G06F 17/30; G06Q 20/32

(52) U.S. Cl. CPC G06Q 30/0224; G06Q 20/322; G06F 17/30864; G06Q 50/01

(57) ABSTRACT

A method and apparatus for incentivizing a person to make a targeted purchase receives online data related to a person's online interaction with a company, and responsively processes the online data to determine behavior data. After determining that the person is within a physical store related to the company, the method and apparatus track the person's movement within the physical store and determine an incentive for making a purchase of a product or service within the store. The incentive is determined as a function of at least the person's position within the physical store and the behavior data. The method and apparatus then forwards an incentive message, having indicia relating to the incentive, to the person when the person is in the store.

### PRIORITY

This patent application claims priority from Indian patent application number 2111/MUM/2014, filed Jun. 30, 2014 entitled, “APPARATUS AND METHOD OF INCENTIVIZING A TARGETED PURCHASE USING MULTI-CHANNEL DATA,” and naming Anupam Raj Gautam, Ravikumar Krishnamoorthy, Venkatesh Babu, Ashok B. Yalamanchili and Suyog Joshi as inventors, the disclosure of which is incorporated herein, in its entirety, by reference.

### FIELD OF THE INVENTION

The invention generally relates to incentivizing behavior using multiple channels of information relating to a given person and, more particularly, the invention relates to tracking behavior and proximity of a person and generating targeted incentives for the person based on the behavior and proximity.

### BACKGROUND OF THE INVENTION

Retailers often attempt to incentivize customers to buy their products by discounting some or all of their items for sale. Traditionally, to accomplish this goal, retailers have blindly sent coupons to potential customers without much information about the potential customers' buying and spending habits. For example, retailers may send coupons to potential customers through a direct mailing campaign or post them in a newspaper. Such a process is expensive and often has a low return on investment.

### SUMMARY OF VARIOUS EMBODIMENTS

In accordance with one embodiment of the invention, a method and apparatus for incentivizing a person to make a targeted purchase receives online data related to a person's online interaction with a company (e.g., historical transaction data relating to the person), and responsively processes the online data to determine behavior data. After determining that the person is within a physical store related to the company, the method and apparatus track the person's movement within the physical store and determine an incentive for making a purchase of a product or service within the store. The incentive is determined as a function of at least the person's position within the physical store and the behavior data. The method and apparatus then forwards an incentive message, having indicia relating to the incentive, to the person when the person is in the store.

Rather than incentivize an in-store purchase, however, the method and apparatus may use both the behavior data and person's movement within the physical store to incentivize an online purchase. In some embodiments, the incentive relates to a discount from the price of the product or service price—whether in the physical store or in an online store. Moreover, tracking may include receiving a proximity signal from a tracking device located within the physical store.

The incentive may be determined any of a wide variety of manners. For example, the incentive may be determined by assigning the person to a pre-defined group associated with the store, and/or selecting a potential product to recommend to the person based on past behavior of the person. In addition, the online data may be obtained from one or more digital media sites, such as at least one of a social media site, an online site related to the store, an application on the person's computer, and an application on the person's mobile device (e.g., a smartphone). Among other things, the acts may be implemented in a SAAS model or PAAS model. Moreover, the method may process the online data by transforming at least a part of the online data into behavior data.

In accordance with another embodiment of the invention, a system for incentivizing a person to make a targeted purchase has a receiver for receiving online data related to 1) a person's online interaction with a company and 2) the person's position within a physical store of the company, and an analytics engine operatively coupled with the receiver. The analytics engine is configured to process the online data to determine behavior data of the person, and to determine an incentive for making a purchase of a product or service within the store. The incentive may be determined as a function of at least the person's position within the physical store and the behavior data. The system uses a transmitter, which is operatively coupled with the analytics engine, to forward an incentive message to the person when the person is in the store. The incentive message has indicia (e.g., text, images, sounds, etc.) relating to the determined incentive.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a simplified network view of one implementation of illustrative embodiments of the invention.

FIG. 2 schematically shows a cross-channel platform implemented in accordance with illustrative embodiments of the invention.

FIG. 3 shows a process of incentivizing a potential customer in accordance with illustrative embodiments of the invention.

### DESCRIPTION OF ILLUSTRATIVE EMBODIMENTS

In illustrative embodiments, a sales system uses a richer set of data to provide focused incentives to potential customers. To that end, the sales system gathers cross-platform customer data from a variety of different platforms, including digital channels, such as the Internet (e.g., Web, mobile, and social media), and physical channels, such as a physical retail store (i.e., so-called physical brick-and-mortar”). Based upon this cross-platform data, the system can provide highly specific and targeted incentives, such as coupons, to potential customers. Details of illustrative embodiments are discussed below.

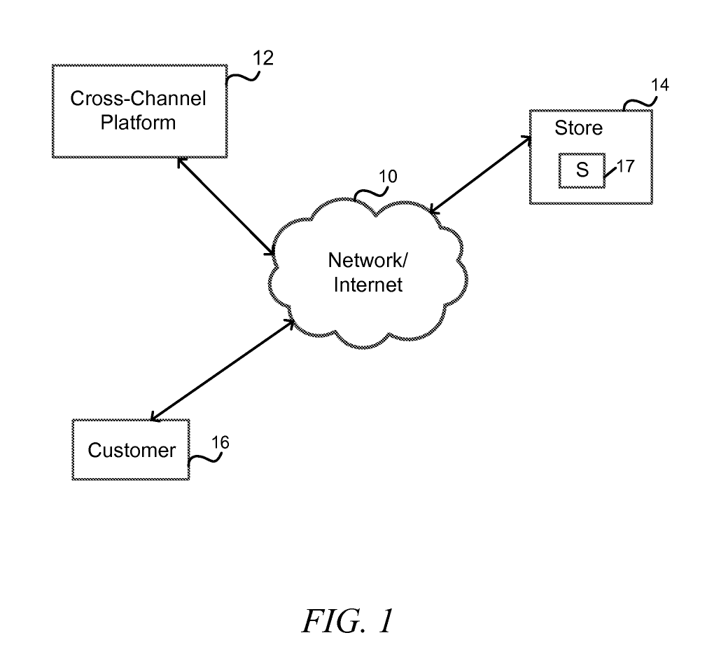

FIG. 1 schematically shows a simplified network view of one implementation of illustrative embodiments of the invention. Specifically, illustrative embodiments communicate with a number of relevant parties across a network 10, such as a local area network (LAN), a wide area network (WAN), or the Internet. To that end, FIG. 1 shows a cross-channel platform 12 that communicates with both the digital footprint of a store 14 (e.g., a vendor of some sort, its online store, social media sites, etc.) and one or more of the physical stores 14 of the retailer to more efficiently and effectively deliver targeted incentives to a potential customer 16 (simply referred to as “customer 16” or the like).

The incentives may include, among other things, coupons, customized offers, information about products or services, raffles, etc. Accordingly, as discussed below, the cross-channel platform 12 uses both online data relating to the customer 16, as well as information about the customer 16 as he/she passes through a physical store (e.g., what the customer 16 purchased while in the physical store, or the customer's location in the physical store), to provide the relevant incentives.

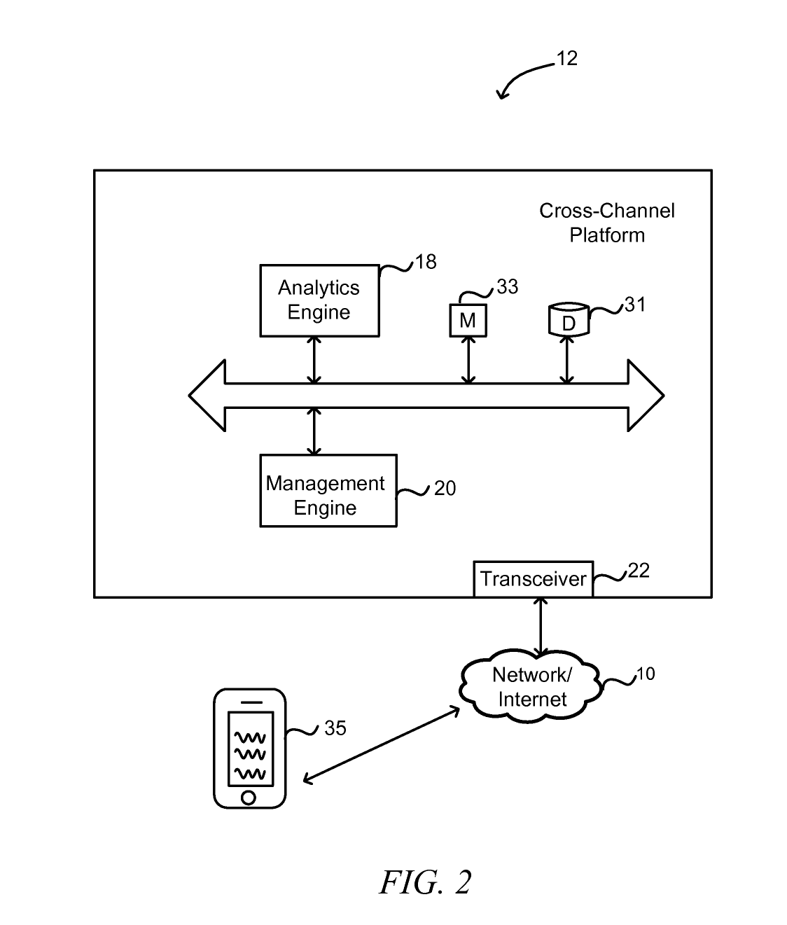

FIG. 2 schematically shows some details of the cross-channel platform 12 configured in accordance with illustrative embodiments of the invention. This platform 12 preferably manages most or all of the process of generating and transmitting incentive messages (discussed below) across the network 10 to customers 16.

To that end, the cross-channel platform 12 primarily includes 1) an analytics engine 18 for both assessing digital and physical data relating to the customer 16, and generating specific incentives, 2) a management engine 20 for managing customer interaction and incentives to customers 16, and 3) a transceiver 22 for sending and receiving messages across the network 10. Each of these components 18, 20, and 22 preferably includes hardware and/or software for completing their tasks. For example, the transceiver 22 may include a network interface card with associated firmware/software, while the analytics engine 18 and management engine 20 may be implemented with digital signal processors, application specific integrated circuits, and/or microprocessors.

Among other things, the analytics engine 18 preferably processes customer touch point interaction, in-store browsing patterns and data feeds from a variety of channels to formulate attractive incentives, such as promotions and offers. The analytics engine 18 also may schedule and trigger promotions across the different channels for various product categories to ensure that the incentive information is delivered to customers 16 during the appropriate times.

Illustrative embodiments of the management engine 20 effectively act as the control node for the entire cross-channel platform 12 and its interaction with other devices. The management engine 20 thus preferably provides a single window of the customer's interactions across multiple channels. It also uses insights from the analytics engine 18 to configure promotional offers, messages, and delivery schedules.

To facilitate use, the management engine 20 may have a cross-channel dashboard, simultaneously or serially providing real-time visibility into the customer's interactions across multiple channels. Either alone or using data from the analytics engine 18, this interactive dashboard may provide a feature-rich, cross-channel interaction with the analytics platform 12 highlighting key metrics, such as transaction value, interaction time per channel, and revenue per channel. Executing on behalf of the retailer or other vendor, the management engine 20 serves as a command center, providing detailed information to manage personalized promotions and incentive programs. In some embodiments, the vendor/store operates the management engine 20, while in other embodiments, a third party may operate the management engine 20.

Each of these portions of the cross-channel platform 12 is operatively connected with some or all of the other portions. For example, the analytics engine 18 is operatively connected with both the management engine 20 and the transceiver 22. A generic bus is shown for this operative connection, although those in the art may make a more complex or other type of connection. Moreover, each of these devices may be implemented as a single, stand-alone device, or across multiple devices. For example, the transceiver 22 may be implemented as an array of input ports, and a separate array of output ports.

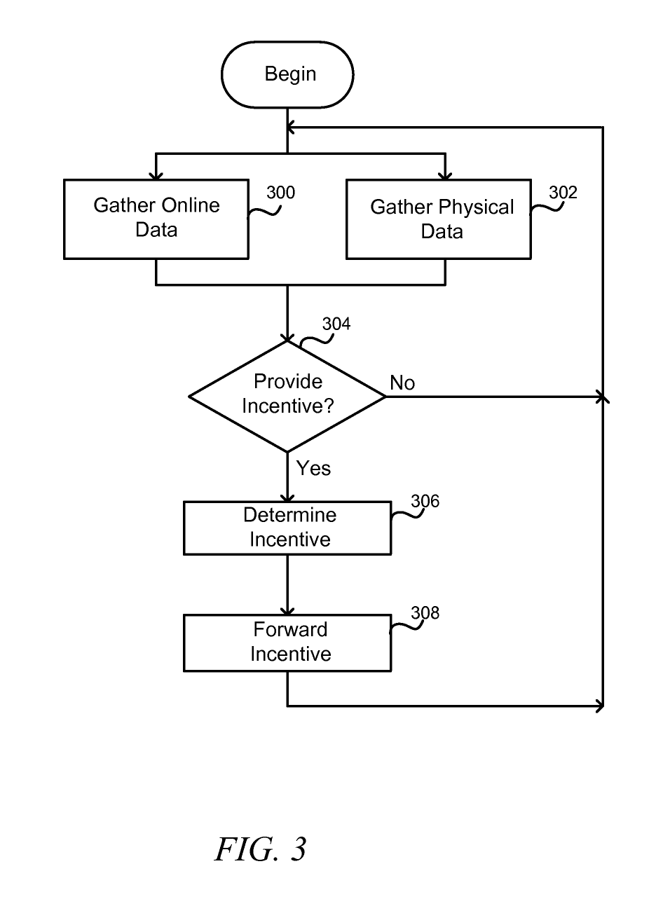

FIG. 3 shows a process managed by the cross-channel platform 12 for incentivizing one or more potential customers 16 in accordance with illustrative embodiments of the invention. It should be noted that the process of FIG. 3 is a simplified version of a longer process. Accordingly, those skilled in the art should understand that the process may have additional steps not specifically discussed, or use more sub-steps during execution of the individual steps. Moreover, although this process is described as being executed by the cross-channel platform 12 of FIGS. 1 and 2, those skilled in the art should understand that systems having similar functionality also may perform this process.

The process of FIG. 3 may be executed in any a variety of models. Among other ways, this process may be executed using an enterprise software model, a software-as-a-service model (“SAAS” model), or a platform-as-a-service model (“PAAS” model).

Illustrative embodiments generally execute this process for one vendor or seller of goods and/or services. Some embodiments, however, may execute this process for multiple vendors or sellers of goods and/or services. For simplicity, however, the process is discussed as applied to a single vendor, such as a retailer, and thus, referred to as “Retailer.” Of course, those skilled in the art should understand that discussion of a single retailer or specific type of vendor is for exemplary purposes only and thus, not intended to limit all embodiments of the invention. For example, this process may apply to multiple retailers, wholesalers, service providers, consultants, etc.

Continuing with the above example, prior to beginning the process, Retailer decides to engage in the process for a single customer 16 (referred to as “Customer”). Accordingly, some or all data/information available to Retailer about Customer are accessible to the cross-channel platform 12 for analysis. More specifically, the process begins at steps 300 and 302, which together gather the relevant online/digital data and physical data relating to Customer.

For example, step 300 may gather information about the Customer's interaction with Retailer's online/ digital footprint, including the Retailer's online storefront and social media sites (e.g., Facebook, Twitter, or LinkedIn Sites). In addition, the retailer also may have a software application on Customer's mobile device (e.g., a smartphone 35, FIG. 3) or personal computer that, after an initial registration process, tracks Customer's physical and online activity with either or both Retailer or, in some cases, third parties. For example, the smartphone application may forward information to the cross-channel platform 12 relating to Customer's purchases from a competing store 14 or vendor, or prior purchases from Retailer's online store.

In a similar manner, step 302 may gather information from the physical world, such as by tracking Customer's location/movement within the physical store of Retailer, or the proximity of Customer to any of its stores in a given metropolitan area. For example, step 302 may determine that Customer is within Retailer's store and, more exactly, in the dairy aisle of the Retailer. This step further may determine that Customer previously stood in from of dry cereal in the dry cereal aisle for some period of time.

The physical store therefore may have one or more electronic beacons/proximity sensors 17 or similar devices (e.g., Bluetooth enabled devices) strategically located in store to identify Customer's location in the dry cereal aisle, and in the dairy aisle. For example, as known by those in the art, a proximity sensor 17 can detect the presence of nearby objects without any physical contact. Among other ways, the proximity sensor 17 may use electromagnetic, electronic, acoustic, light, radio frequency (RF), or other mechanism to detect proximity of Customer. A transmitter or similar device may transmit a signal to the platform 12 with proximity information about Customer.

In addition to signaling that Customer is in the store, the proximity sensor 17 may transmit a more specific proximity signal (indicating movement and/or position of Customer) to the platform 12 for processing. In this case, the analytics engine 18 may calculate the likelihood that Customer purchased dry cereal based on Customer's location in the cereal aisle, the speed the Customer walked through that aisle, and the time spent in that aisle. As discussed below, this information may be taken into account to incentivize Customer to purchase a complimentary item; specifically, milk.

The platform 12 may store the retrieved data in a database 31. Accordingly, when needed, the analytics engine 18 or other part of the platform 12 may use a local database management system 33 to retrieve the data from the database 31 for processing.

Indeed, this data obtained from steps 300 and 302, as well as the instructions from the analytics engine 18 and/or management engine 20, are sent and received to the cross-channel platform 12 through the transceiver 22. The process then continues to step 304, in which the management engine 20 determines if the platform 12 should provide an incentive to Customer based upon the data it has gathered. If not, then the process loops back to steps 300 and 302, continuing to gather online and physical data. Otherwise, if the process is to provide an incentive, the management engine 20 may query the analytics engine 18 to determine if it has enough data to make a recommendation. Alternatively, the analytics engine 18 simply may forward a message indicating one or more potential incentives it should provide.

Accordingly, the process continues to step 306, in which the management engine 20 and analytics engine 18 collaborate to determine an appropriate incentive for Customer. In the example above, the platform 12 may have information indicating that Customer enjoys dry cereal for breakfast (i.e., from past behavior—Customer buys a lot of dry cereal). Among other ways, that information may be determined by accessing data from Retailer's customer loyalty program indicating the prior purchasing patterns of Customer, or from Customer's posts to Retailer's Facebook page or Twitter feeds.

The analytics engine 18 then combines this digital data obtained from digital channels with the actual physical activity of Customer to generate an appropriate incentive. Again, using the simplified example above, the analytics engine 18 may recognize that this person very likely will buy milk because Customer is physically located in the dairy aisle, and the digital information relating to Customer's habit of eating dry cereal. Accordingly, the analytics engine 18 may suggest a 10 percent or 15 percent discount from the list price of milk.

Of course, the analytics engine 18 may use any of a number of techniques for determining an appropriate incentive. These techniques may include artificial intelligence and/or other related technologies. In one embodiment, the analytics engine 18 uses a several-step process for recommending customer incentives. Specifically, that embodiment first may form two or more categories of customers 16, and then determine the likelihood Customer will purchase a certain product or service while in the physical store.

For example, high-value customers 16 may be categorized into a Gold category, middle-value customers 16 may be categorized into a Silver category, and low-value customers 16 may be categorized into a Bronze category. The Gold customers 16 may receive the most competitive incentives, while the Bronze customers 16 may receive the least competitive incentives. Accordingly, this embodiment may determine that Customer is a Gold customer 16, and is likely to purchase milk while in the dairy aisle if properly incentivized. As a Gold customer 16, the analytics engine 18 may recommend a 15 percent discount for milk, which may be the maximum discount for obtaining a reasonable profit on the milk. If Customer were a Silver customer 16, then the analytics engine 18 may recommend a 10 percent discount.

After determining an appropriate incentive for Customer, the process continues to step 308, which forwards the incentive to Customer. Customer receives the message in some manner known in the art, such as on his/her smartphone 35. Some embodiments alternatively or additionally may direct the incentive message to an in-store Bluetooth or RF device in the aisle. Thus, as Customer is in front of the device in the appropriate aisle, it automatically ejects a coupon or otherwise identifies some incentive to Customer. As another example, the in-store device may illuminate a sign saying that a certain brand of milk is organic and on-sale—without providing a coupon.

The management engine 20 may generate an incentive message having text or other indicia indicating the prescribed discount, such as a 15 percent discount for milk. The indicia may include data for generating, on the smartphone 35 or other device of Customer or Retailer, one or more of (among other things) graphical indicia (e.g., a picture of a coupon), text, audible signal(s), mechanical signals (e.g., a vibration in the smartphone 35), etc. For example, Customer's smartphone 35 may make a ringing sound and simultaneously display text with a QR code or other indicia capable of scanning to be used as a 15 percent off coupon. In a similar manner, the incentive message may be in any of a wide variety of other formats, such as a text message, electronic mail message, or other electronic signal directed toward Customer—either directly or via a device of Retailer.

After completing step 308, the process loops back to step 300 and 302, continuing to gather data about Customer.

Accordingly, rather than relying on only digital data (e.g., Customer loyalty program information or social media interactions), or only physical data (e.g., Customer's location in the physical store), illustrative embodiments use information from both physical and digital channels to obtain a more complete view of Customer. This complete view enables entities selling goods or services to provide more targeted incentives, consequently improving marketing efficiency and profits. Moreover, Retailer may use the captured movement patterns to generate heat maps that provide insights into what motivates customers 16 to connect with certain brands and channels. These heat maps may provide inputs for store layout optimization and merchandising strategies. Some embodiments vary from the process described in FIG. 3 by providing incentives that are usable in Retailer's digital store. For example, the management engine 20 may forward an incentive message having a coupon for purchasing dry cereal through its online store. Such a coupon may or may not be usable in Retailer's physical store.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of incentivizing a person to make a targeted purchase, the method comprising:
receiving online data related to a person's online interaction with a company;
processing, at a host computing platform, the online data to determine behavior data;
receiving a proximity signal from at least one proximity sensor indicating that the person is within a physical store related to the company;
tracking, using the proximity signal from the at least one proximity sensor, the person's movement within the physical store;
determining an incentive for making a purchase of a product or service within the store, the incentive being determined as a function of at least the person's position within the physical store and the behavior data; and
forwarding an incentive message to the person when the person is in the store, the incentive message including indicia relating to the determined incentive.

2. The method as defined by claim 1 further comprising storing the behavior data in a database, and using a database management system to retrieve the behavior data for determining an incentive.

3. The method as defined by claim 1 wherein the incentive relates to a discount from the price of the product or service price.

4. The method as defined by claim 1 wherein tracking includes receiving a proximity signal from a tracking device located within the physical store.

5. The method as defined by claim 1 wherein determining an incentive comprises assigning the person to a pre-defined group associated with the store.

6. The method as defined by claim 1 wherein determining an incentive comprises selecting a potential product to recommend to the person based on past behavior of the person.

7. The method as defined by claim 1 further comprising gathering the online data from one or more digital media sites.

8. The method as defined by claim 1 wherein the online data is obtained from at least one of a social media site, an online site related to the store, an application on the person's computer, and an application on the person's mobile device.

9. The method as defined by claim 8 wherein the mobile device comprises a smartphone, the method displaying the indicia.

10. The method as defined by claim 1 wherein processing comprises transforming at least a part of the online data into behavior data.

11. The method as defined by claim 1 wherein forwarding comprises forwarding the incentive message to a mobile device registered with the person and the store, the incentive message is configured to cause the mobile device to display the incentive when the person is at a prescribed location within the physical store.

12. The method as defined by claim 1 wherein the physical store is a retail store.

13. A computer program product for use on a computer system for incentivizing a person to make a targeted purchase, the computer program product comprising a tangible, non-transient computer usable medium having computer readable program code thereon, the computer readable program code comprising:
program code for receiving online data related to a person's online interaction with a company;
program code for processing, at a host computing platform, the online data to determine behavior data;
program code for receiving a proximity signal from at least one proximity sensor indicating that the person is within a physical store related to the company;
program code for tracking, using the proximity signal, the person's movement within the physical store;
program code for determining an incentive for making a purchase of a product or service within the store, the incentive being determined as a function of at least the person's position within the physical store and the behavior data; and
program code for forwarding an incentive message to the person when the person is in the store, the incentive message including indicia relating to the determined incentive.

14. The computer program product as defined by claim 1 wherein the incentive relates to a discount from the price of the product or service price.

15. The computer program product as defined by claim 1 wherein the program code for tracking includes program code for receiving a proximity signal from a tracking device located within the physical store.

16. The computer program product as defined by claim 1 wherein the program code for determining an incentive comprises program code for assigning the person to a pre-defined group associated with the store.

17. The computer program product as defined by claim 1 wherein the program code for determining an incentive comprises program code for selecting a potential product to recommend to the person based on past behavior of the person.

18. The computer program product as defined by claim 1 further comprising gathering the online data from one or more digital media sites.

19. The computer program product as defined by claim 1 wherein the online data is obtained from at least one of a social media site, an online site related to the store, an application on the person's computer, and an application on the person's mobile device.

20. The computer program product as defined by claim 7 wherein the mobile device comprises a smartphone.

21. The computer program product as defined by claim 1 wherein the program code is implemented in a SAAS model or a PAAS model.

22. A system for incentivizing a person to make a targeted purchase, the apparatus comprising:
a receiver for receiving online data related to 1) a person's online interaction with a company and 2) the person's position within a physical store of the company from a proximity sensor;
an analytics engine operatively coupled with the receiver, the analytics engine being configured to process the online data to determine behavior data of the person, the analytics engine also being configured to determine an incentive for making a purchase of a product or service within the store, the incentive being determined as a function of at least the person's position within the physical store and the behavior data; and
a transmitter operatively coupled with the analytics engine, the transmitter being configured to forward an incentive message to the person when the person is in the store, the incentive message including indicia relating to the determined incentive.

23. The system as defined by claim 22 wherein the incentive relates to a discount from the price of the product or service price.

24. The system as defined by claim 1 wherein the receiver is configured to receive a proximity signal from a tracking device located within the physical store.
